(19) United States
(12) Patent Application Publication
(10) Pub. No.: US 2015/0322896 A1
(43) Pub. Date: Nov. 12, 2015

(54) INTERNAL COMBUSTION ENGINE AND METHOD FOR OPERATING THE SAME

(71) Applicant: GE Jenbacher GmbH & Co OG, Jenbach (AT)

(72) Inventors: Georg ARNOLD, Innsbruck (AT); Erwin AMPLATZ, Buch in Tirol (AT); Herbert KOPECEK, Schwaz (AT); Herbert SCHAUMBERGER, Muenster (AT); Nikolaus SPYRA, Innsbruck (AT)

(21) Appl. No.: 14/706,211

(22) Filed: May 7, 2015

(30) Foreign Application Priority Data
May 9, 2014 (AT) 345/2014

(51) Int. Cl. F02M 23/10; F02M 21/02

(52) U.S. Cl. CPC F02M 23/10; F02M 21/0209; F02M 21/0206

(57) ABSTRACT

Internal combustion engine includes at least one combustion chamber to which air, a combustion gas, and a stabilizing gas can be supplied. At least one sensor measures at least one engine variable and an open-loop or closed-loop control device is connected to the at least one sensor. Due to the open-loop or closed-loop control device, a quantity of the stabilizing gas supplied to the at least one combustion chamber can be controlled by open-loop or closed-loop control in dependence on the at least one engine variable.

The present invention relates to an internal combustion engine according to the features of the preamble of claim 1, and to a method for operating an internal combustion engine according to the features of the preamble of claim 9.

There are several applications of internal combustion engines, wherein the latter are operated with a fuel that has a relatively low heating value and, in some cases, moreover, a heating value that varies greatly. A specific example that may be cited is that of a gas engine operated with a so-called low-BTU gas that originates, for example, from a coal mine. Since this low-BTU gas (BTU: British Thermal Unit) not only has a low heating value, but also a greatly varying heating value, it is state of the art to admix with the combustion gas a stabilizing gas that ensures combustion even when the combustion gas temporarily has a very low heating value. This is realized, for example, in the series 6, model 620 E51 of the applicant.

The admixture is effected such that this condition of ensuring combustion is only just fulfilled. The sparing use of stabilizing gas is necessary because this gas has to be bought in and, owing to its better combustibility, is usually more expensive than the combustion gas.

Stabilizing gases used here are preferably gases containing hydrogen and/or methane, for example pure hydrogen or pure methane, as well as natural gas or coke-oven gas. In principle, however, it is possible to use as a stabilizing gas any gas that enables an internal combustion engine to be operated continuously.

The aim, described above, of using as little stabilizing gas as possible has given rise to a further development. It is known to measure the composition of the combustion gas continuously before it is supplied to the internal combustion engine, and to determine from this the heating value that is present just then. In this way, if the combustion gas just then has a particularly low heating value, more stabilizing gas can be supplied selectively. A disadvantage in this case is that the measuring instruments required for analysing the combustion gas, for example gas chromatographs or mass spectrometers, are very elaborate. These analysis methods are relatively slow, with the result that it is not possible for stabilizing gas to be admixed precisely according to requirements in the case of rapidly changing heating values of the combustion gas. Moreover, they are expensive, and there is an increased risk of failure, with the result that it is again necessary to return to the method, described at the outset, of a constant admixture of stabilizing gas.

The object of the invention is to provide an internal combustion engine and a method for operating an internal combustion engine, wherein it is possible to achieve reliable operation in the burning of combustion gas having a heating value that is variable and/or too low, as well as efficient use of stabilizing gas.

This object is achieved by an internal combustion engine having the features of claim 1, and by a method having the features of claim 9.

This is effected in that a quantity of the stabilizing gas supplied to the at least one combustion chamber is controlled by open-loop or closed-loop control in dependence on the at least one engine variable.

The invention is thus based on the knowledge that, in many cases, sensors that are already present on the internal combustion engine can be used to sense the quality of the combustion. The invention thus makes it possible to use stabilizing gas in an efficient and selective manner, with the resource requirement for measuring elements remaining substantially the same.

Also in the opposite case, in which the combustion gas has a heating value that is too high for the internal combustion engine, stable operation can be ensured by means of a stabilizing gas. By using a stabilizing gas here that has a lower heating value, it can be achieved that a gas mixture having a heating value that is acceptable for the internal combustion engine is always present in the combustion chamber.

Moreover, according to the invention, stabilizing gas can also be used if other parameters of the combustion gas are not suitable for the available internal combustion engine. An important example here is the flame speed. This means that if there is a combustion gas that has a flame speed which is too low (too high), a stabilizing gas having a higher (lower) flame speed can be admixed, in order to provide in total a mixture that has the correct flame speed for the internal combustion engine.

If a plurality of parameters of the combustion gas are unsuitable for the internal combustion engine, it is clearly also possible to use a plurality of differing stabilizing gases in order to adapt the gas to be burned.

All possible applications of an internal combustion engine of the generic type, or of a method of the generic type, that are discussed in respect of the state of the art can also be provided in the case of an internal combustion engine, or a method, according to the invention.

Further advantageous embodiments of the invention are defined in the dependent claims.

Preferably, the invention can be used in the case of gas engines having 8, 10, 12, 16, 18, 20, 22 or 24 cylinders.

Preferably, the invention is used in the case of, in particular externally ignited, stationary internal combustion engines, which are preferably coupled to an electric generator for the purpose of generating electricity or which are used to directly drive machines, in particular pumps and compressors.

A quantity of stabilizing gas, combustion gas or air supplied to the at least one combustion chamber may preferably be understood to mean an amount of substance of the gases. Basically, for example, a quantity based on a mass-based concept of amount may be used for closed-loop control or open-loop control. However, it is also possible, for example, to specify the amount of the gases in terms of their chemical energy content.

Preferably, there may be an embodiment in which a lambda probe, connected to the open-loop or closed-loop control device, is provided to measure a lambda value (air excess number) as an engine variable. The lambda probe may preferably be disposed in the exhaust tract. The measured lambda value can then be used for the closed-loop control or open-loop control of the supply of the stabilizing gas.

The lambda value may likewise be determined in the inlet pipe, by measurement of the oxygen content, and supplied to the engine closed-loop control system.

Alternatively or additionally, the lambda value may be determined by means of an oxygen sensor, since the lambda value can be deduced from the measurement values of the oxygen sensor. Clearly, it is also possible to use other sensors the measurement values of which allow the lambda value to be determined. An example that might be cited is that of a carbon monoxide probe.

Preferably, furthermore, there may be an embodiment in which at least one sensor, connected to the open-loop or closed-loop control device, is provided to measure, as an engine variable, at least one pressure of a mixture of combustion gas, stabilizing gas and air that is present in the at least one combustion chamber during a combustion. A time variable that is characteristic of the speed of combustion of the gas present in the at least one combustion chamber can be calculated from the thus sensed cylinder pressure. Such a time variable can also be advantageously taken into account in the open-loop control or closed-loop control of the stabilizing gas.

Wherever the present disclosure mentions a pressure sensor,

it is likewise conceivable to use
an ionic current sensor or
a sensor for sensing the temperature in the at least one combustion chamber.

The measurement values of these sensors can also be used to deduce the characteristic combustion progression.

In a particularly preferred embodiment of the invention, precisely one sensor—in particular a pressure sensor—is provided per combustion chamber. In this way, an individual time variable can be calculated for each combustion chamber. In a further preferred embodiment, it may be provided that these individual time variables are averaged, or a median of the individual time variables is calculated, in order to improve the accuracy of the time variable to be calculated. It is also conceivable, however, for the admixtures of the stabilizing gas to be controlled individually for each combustion chamber, by open-loop or closed-loop control.

In the determination of the time variable and/or of the individual time variable, it is possible to draw on the so-called “mass fraction burned” (MFB). For the definition of the same, reference may be made to sections 9.1 and 9.2, in particular 9.2.1 and 9.2.2 of the technical book “Internal Combustion Engine Fundamentals” by Heywood (McGraw-Hill, 1988). An instant of time at which the MFB attains a defined proportion of its maximum may be used as a time variable and/or individual time variable. For the present invention, preferred values for this proportion are between 30% and 80%, in particular between 40% and 65%, particularly preferably are 50%. The time variable and/or individual time variable produced in this way is referred to as MFB50 (in the case of a 50% proportion; analogous for other selected proportions).

The proportion may also be between 0% and 10%. The time variable and/or individual time variable is then referred to as ignition delay. For the definition of the same, reference may be made to section 9.2.3 of the technical book “Internal Combustion Engine Fundamentals” by Heywood (McGraw-Hill, 1988).

In a particularly preferred embodiment of the invention, it may be provided that, during the combustion, a pressure progression in the at least one combustion chamber is measured by means of the at least one pressure sensor, and used to calculate the time variable. This may preferably be effected by measurement of a multiplicity of pressure values by the at least one pressure sensor. The more pressure values that are supplied by the at least one pressure sensor per combustion, i.e. the greater the time resolution of the measured pressure progression, the greater the precision with which the time variable determined therefrom can be calculated.

This applies in particular to the following development of this embodiment. It may be provided that a heating progression is calculated as a difference of the pressure progression and a motored pressure progression, and a cumulative heating progression is calculated as an integral of the heating progression, and the cumulative heating progression is used to calculate the time variable. The motored pressure is to be understood to mean a progression of the pressure in the combustion chamber without combustion. For example, in the case of a piston-cylinder unit, the pressure changes periodically during motored operation, even if no combustion occurs. The motored pressure progression can be determined experimentally, by means of a simulation or by an analytic calculation. This embodiment makes it possible to capture the exact combustion progression in the combustion chamber.

A time variable or individual time variable based on the MFB can be easily determined from the heating progression, in that an instant of time at which the cumulative heating progression attains a defined proportion of its maximum is used as a time variable or as an individual time variable, wherein the proportion is between 30% and 80%, preferably between 40% and 65%, and particularly preferably is 50%.

Alternatively or additionally, a proportion between 0% and 20% may also be used. In this case, the time variable or individual time variable is referred to as ignition delay.

The use of the ignition delay may be advantageous, since at the start of combustion there are relatively simple flow conditions prevailing in the cylinder (for example, in comparison with the instant of time of the 50% mass fraction burned point). A prerequisite for this is a pressure level, at the start of the combustion process, that is sufficiently high for the at least one pressure sensor.

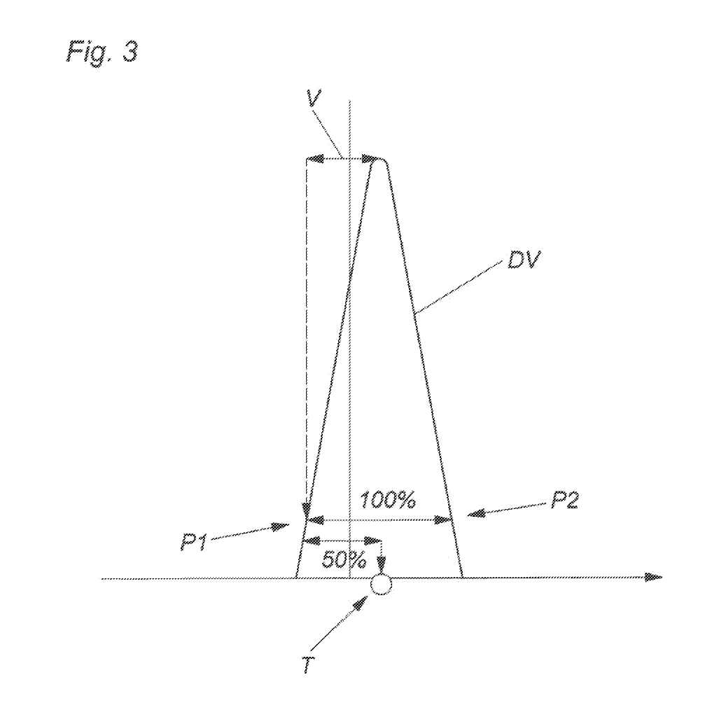

However, the time variable may also be calculated in other ways. Some examples that may be cited:
maximum of the differential heating law,
determination of the centroid of the differential heating law,
the position of the peak value of the cylinder pressure (in this way, a 50% mass fraction burned point can be determined very easily)
evaluation of the cylinder pressure flanks (this method is described briefly in the description of the figures, see FIG. 3).

In a particularly preferred embodiment of the invention, it may be provided to use both a lambda probe and at least one pressure sensor that is disposed in the at least one combustion chamber. It is also conceivable, however, to calculate the lambda value from measurement values of the at least one pressure sensor, instead of measuring it by means of a lambda probe.

Further advantages and details of the invention are disclosed by means of the figures and the associated description of the figures. There are shown in:

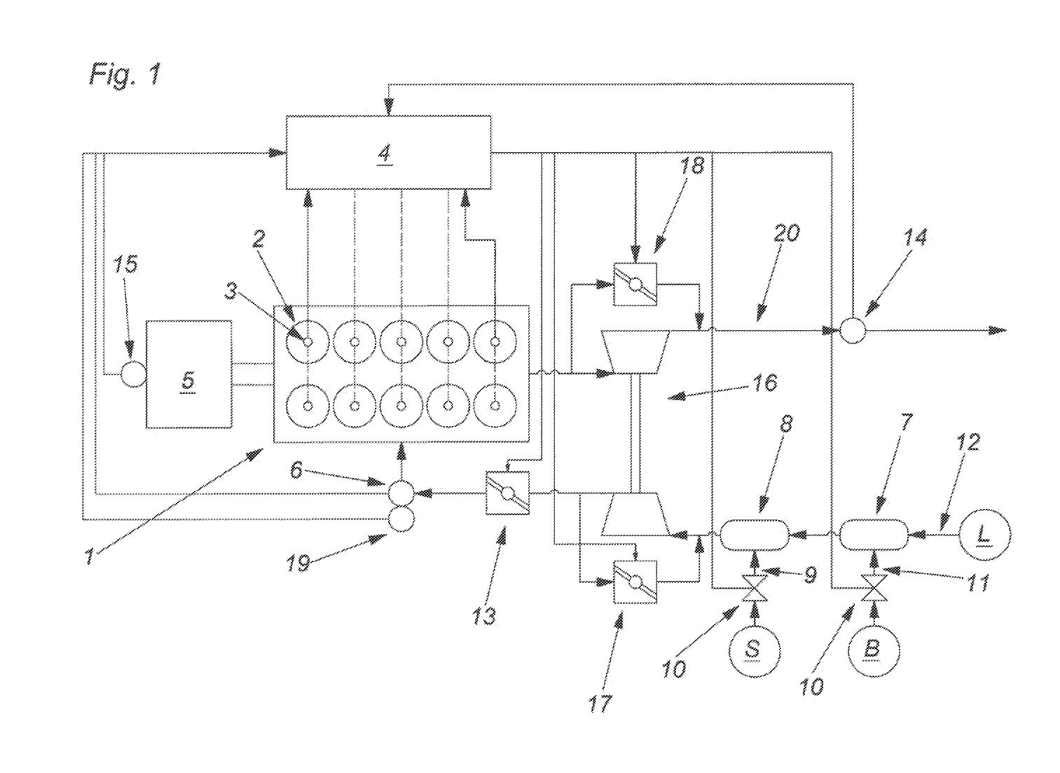

FIG. 1 a schematic representation of an internal combustion engine according to the invention,

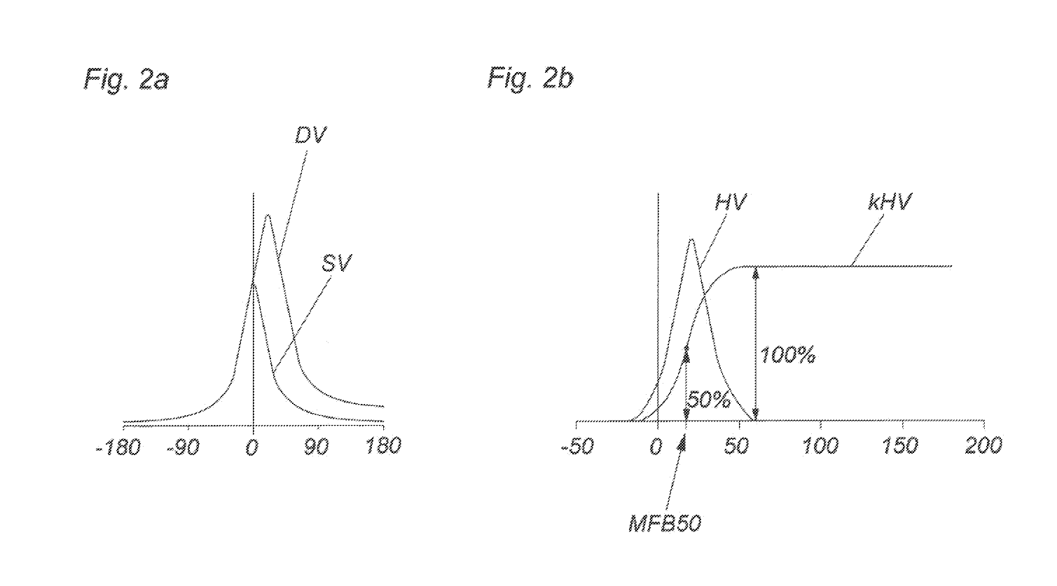

FIGS. 2a and 2b two diagrams for the determination of the time variable, in a first embodiment,

FIG. 3 a diagram for the determination of the time variable, in a second embodiment, and

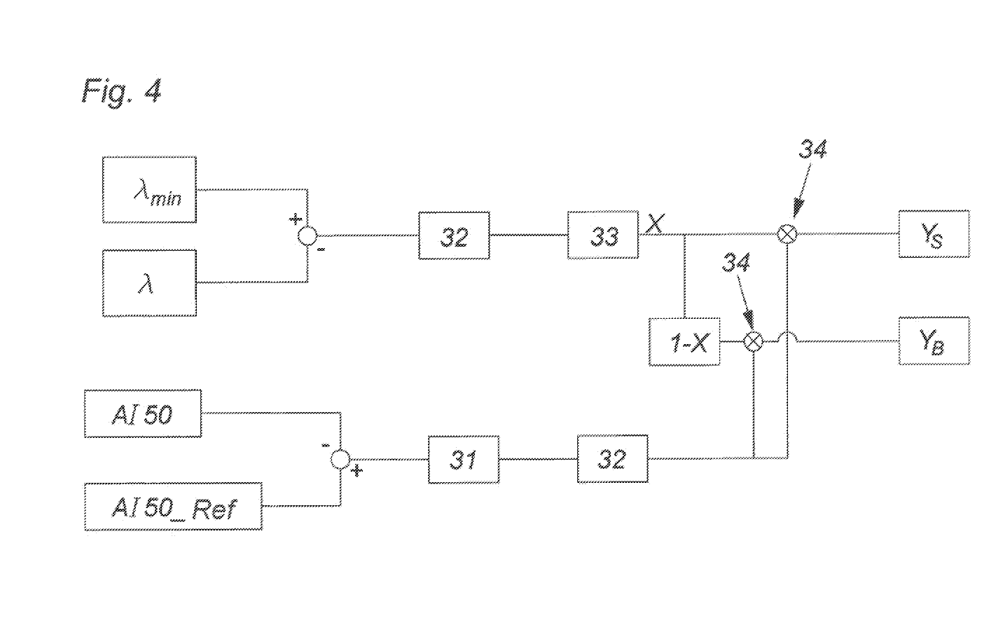

FIG. 4 a closed-loop control concept of an internal combustion engine according to the invention, or of a method according to the invention.

The internal combustion engine 1 has a supply of combustion gas B and stabilizing gas S. The combustion gas B is supplied to a first mixing device 7 via a combustion-gas supply line 11. The first mixing device 7 is additionally supplied with air L, via the air supply line 12. The premix produced in the first mixing device 7 is supplied to a second mixing device 8. In the second mixing device 8, stabilizing gas S is admixed with the premix, via the stabilizing-gas supply line 9, thereby producing the main mixture that is supplied to the combustion chambers 2. Purely as an example, ten combustion chambers 2 are represented. For the invention per se, however, the number of combustion chambers 2 is immaterial. For reasons of clarity, not all of the combustion chambers 2 and not all of the pressure sensors 3 are denoted by references.

Particularly in the case of mine gas or pit gas, the air supply line 12 and the supply of the combustion gas B may be interchanged, unlike as represented, with the result that the combustion gas B thus flows in freely, and air is metered in via a regulating valve 10.

In this embodiment example, the combustion chambers are realized as piston-cylinder units. A turbocharger 16 is provided. There may also be a plurality of turbochargers 16 (not represented).

The turbocharger 16 has a bypass valve 17 on the compressor side and has a waste gate 18 on the turbine side. By means of these, the boost pressure and the quantity of charge air can be influenced very rapidly, thereby enabling the power output of the internal combustion engine 1 and the emissions to be controlled by closed-loop control.

In this embodiment example, the internal combustion engine 1 drives a generator 5 for the purpose of generating electricity.

In the exhaust-gas line 20 there is a lambda probe 14, which is connected to the closed-loop control device 4. For the functioning of the closed-loop control device 4, reference may be made to FIG. 4.

For each combustion chamber 2, a respective pressure sensor 3 is provided, which measures the pressure progressions during the combustion in the combustion chambers 2. The measurement values are transmitted to the closed-loop control device 4, which uses them to calculate the time variable. This is effected according to the method described further below with reference to FIGS. 2a and 2b.

In addition to the measurement values of the lambda probe 14 and of the pressure sensors 3, the closed-loop control unit 4 is supplied with the measurement values of the boost pressure sensor 6, of the charging temperature sensor 19, and of a power sensor 15 on the generator 5. The closed-loop control device 4 influences the regulating valves 10 present in the combustion-gas supply line 12 and stabilizing-gas supply line 9. In this embodiment example, these valves are realized as flow-rate control valves.

As an alternative to the use of a charging-temperature sensor 19, described in the preceding paragraph, a charge-air quantity sensor may also be used.

Furthermore, the closed-loop control device 4 influences the throttle valve 13, the bypass valve 17 on the compressor side, and the waste gate 18.

The combustion chambers and their ignition devices are to be realized according to the state of the art. Clearly, it is possible for the present invention to be combined with other known techniques. For example, exhaust-gas recirculation or reforming can be effected without difficulty.

The pressure progression DV measured by the pressure sensors 3 is represented in FIG. 2a. In this case, the position of the respective piston is used as a time unit. This position is indicated by the position of the corresponding cranking of the crankshaft, wherein 0° denotes the top dead centre of the piston.

FIG. 2a additionally shows the motoring progression SV, i.e. the progression of the cylinder pressure that ensues when the gas in the cylinder is not ignited. In this case, the motoring progression was calculated analytically. The heating progression HV, which is represented in FIG. 2b, can be calculated from the difference of the pressure progression DV and motoring progression SV. Also represented in this figure is the cumulative heating progression kHV, which represents the integral of the heating progression HV. The position of the crankshaft that marks the attainment of 50% of the maximum of the cumulative heating progression, denoted as MFB 50 (Mass Fraction Burned 50%), is used as a time variable.

The heating progression HW is described in the technical literature (Heywood, “Internal Combustion Engine Fundamentals”, 1988, page 387 et seq.).

Clearly, other percentage figures are suitable for defining the time variable.

The MFB 50 is also referred to as the AI 50 (Angle Integrated 50%).

FIG. 3 illustrates a further embodiment for the determination of the time variable from the pressure progression DV. In this case, the maximum of the pressure progression is determined, and the point P1, which precedes the pressure maximum by an offset V on the curve of the pressure progression DV, is ascertained. A second point P2, which is located on the right flank of the pressure progression DV and has the same pressure value as P1, is then determined. In this method, it is possible to ascertain the points P1 and P2 by sliding mean values, which increases the accuracy.

A value between the two time coordinates of the points P1 and P2 is used as a time variable or individual variable, wherein a division of 50% is normally used. Clearly, the use of other divisions (40% to 60%, 30% to 70%) is also conceivable.

The closed-loop control of internal combustion engine 1 according to the embodiment from FIG. 1 is explained in the following. The required quantity of combustion gas B and stabilizing gas S is set by means of the closed-loop control device 4, on the basis of the lambda value λ or also, directly, of the oxygen content.

The closed-loop control by means of the lambda probe 14 is preferably combined with the closed-loop control by means of the combustion sensors (e.g. pressure sensors 3), in order to ensure an optimally stable and robust engine operation.

The open-loop control or closed-loop control may be realized such that, if the time variable is over a certain limit value, more combustion gas and stabilizing gas is supplied (at a constant ratio). If the lambda value λ is not within an acceptable range, the ratio of combustion gas B to stabilizing gas S is adjusted.

The closed-loop control can thus ensure that the internal combustion engine 1 is always operated with gas-air mixtures having lambda values λ>1.0, which is advantageous for stable operation and for low emissions and feasible efficiencies.

A corresponding closed-loop control concept is represented in FIG. 4.

Stored in the closed-loop control device 4 there is a reference value for the AI50 (denoted as AI50_Ref) and a minimum lambda value λₘᵢₙ.

The measurement value A is compared with λₘᵢₙ, and the result is supplied to a proportional controller 31. (In the present embodiment example, λₘᵢₙ=1.1).

The use of a proportional controller 31 is not essential for the invention. Another type of controller or a characteristic diagram may also be used.

The value X, produced by the proportional controller 31, which parameterizes the ratio of combustion gas B to stabilizing gas S, is then held below a predefined saturation limit Xₛₐₜ (for example, X<=0.2) by a saturator 33. (X is a value between 0 and 1, and is defined as the ratio of the amount of substance of the stabilizing gas S to the total amount of substance of stabilizing gas S and combustion gas B). This means that, if the value X is greater than Xₛₐₜ, the saturator 33 replaces X by Xₛₐₜ. The procedure is similar if the input value for the saturator 33 becomes negative, i.e. in the case of negative input values the saturator 33 outputs X=0.

If the value X produced by the proportional controller 31 attains the saturation limit Xₛₐₜ (e.g. Xₛₐₜ=0.2), the output power of the internal combustion engine 1 is reduced in proportion to the deviation X-Xₛₐₜ. For reasons of simplicity, the output power closed-loop control circuit, known per se, is not represented.

The value X serves as a basis for the amount of the stabilizing gas supplied. 1−X serves as a basis for the amount of the combustion gas supplied.

To aid comprehension, a numerical example is to be given. If the measured lambda value λ is equal to the minimum lambda value λₘᵢₙ, i.e. λ=λₘᵢₙ, the value 0 is supplied to the proportional controller 31, which forwards this value, unchanged, to the saturator 33. Since 0 is within the allowed value range of the saturator 33, the latter outputs X=0. If the gas composition then changes, such that the measured lambda value changes to λ=1.0, the comparison between A and λₘᵢₙ produces the value 0.1. For this numerical example, the constant of the corresponding proportional controller 31 is to be equal to 1. The saturator 33 thus likewise receives the value 0.1. Since 0.1 is likewise within the value range of the saturator 33, the latter outputs X=0.1. This means that, in this case, 10% stabilizing gas S is admixed (relative to the total amount of substance or, also, to the energy contents of stabilizing gas S and combustion gas B).

AI50_Ref is compared with the actual AI50 determined by the pressure sensors 3, and supplied to a decision unit 31. The decision unit 31 ascertains whether the deviation between an actual AI50 and AI50_Ref exceeds a certain limit value (for example: |AI50−AI50_Ref|>3°).

If this is the case, the deviation is supplied, for example, to a further proportional controller 32 and, by means of the result present after the further proportional controller 32, the quantity of the stabilizing gas S and of the combustion gas B is altered by the same factor. In the present embodiment example, this is effected by multipliers 34.

Alternatively or additionally, it is also possible to intervene in the ratio of stabilizing gas S and combustion gas B. This means that, unlike as described in the preceding paragraph, the amounts of substance or energy contents of gases are not altered by the same factor.

Output as results to the regulating valves 10 are Y_{S} for the amount of substance of the stabilizing gas to be supplied and Y_{B} for that of the combustion gas to be supplied.

1. Internal combustion engine, with
at least one combustion chamber, to which air a combustion gas and a stabilizing gas can be supplied,
at least one sensor for measuring at least one engine variable, and an open-loop or closed-loop control device, which is connected to the at least one sensor,
wherein by means of the open-loop or closed-loop control device, a quantity of the stabilizing gas supplied to the at least one combustion chamber can be controlled by open-loop or closed-loop control in dependence on the at least one engine variable.

2. Internal combustion engine according to claim 1, wherein a lambda probe and/or an oxygen sensor, connected to the open-loop or closed-loop control device, is provided to measure a lambda value as an engine variable.

3. Internal combustion engine according to claim 1, claim 1, wherein at least one sensor, preferably realized as a pressure sensor, is provided to measure, as an engine variable, at least one pressure of a mixture of combustion gas, stabilizing gas and air that is present in the at least one combustion chamber during the combustion, wherein the at least one sensor is connected to the open-loop or closed-loop control device.

4. Internal combustion engine according to claim 1, wherein at least one ionic current sensor is provided to sense the combustion state.

5. Internal combustion engine according to claim 3, wherein precisely one sensor is provided per combustion chamber.

6. Internal combustion engine according to claim 3, wherein the open-loop or closed-loop control device is designed to calculate, from the measurement values of the at least one sensor, a time variable that is characteristic of the speed of combustion of the gas present in the at least one combustion chamber, and to control, by open-loop or closed-loop control in dependence on the time variable, the quantity of the stabilizing gas supplied to the at least one combustion chamber.

7. Internal combustion engine according to claim 1, wherein a first mixing device is provided to produce a premix of combustion gas and air, and a second mixing device, which is connected to the first mixing device, is provided to produce a main mixture composed of the premix and stabilizing gas, wherein the main mixture can be supplied to the at least one combustion chamber.

8. Internal combustion engine according to claim 1, wherein a regulating valve, which is connected to the open-loop or closed-loop control device, is provided in a stabilizing-gas supply line for providing stabilizing gas.

9. Method for operating an internal combustion engine, wherein
air, a combustion gas and a stabilizing gas are supplied to at least one combustion chamber,
gas present in the at least one combustion chamber is ignited,
at least one engine variable is measured on the internal combustion engine by means of at least one sensor,
wherein
a quantity of the stabilizing gas supplied to the at least one combustion chamber is controlled by open-loop or closed-loop control in dependence on the at least one engine variable.

10. Method according to claim 9, wherein a lambda probe and/or an oxygen sensor is used as a sensor, and a lambda value, measured by the lambda probe and/or determined by means of measurement values of the oxygen sensor, is used as an engine variable.

11. Method according to claim 10, wherein the quantity of the supplied stabilizing gas is increased if a lower lambda limit value is fallen below.

12. Method according to claim 9, wherein a sensor is used to measure a pressure, as an engine variable, in the at least one combustion chamber, wherein a pressure sensor is preferably used as a sensor.

13. Method according to claim 12, wherein a time variable that is characteristic of the speed of combustion of the mixture of combustion gas, stabilizing gas and air that is present in the at least one combustion chamber is calculated from the at least one measured pressure, and the quantity of the stabilizing gas supplied to the at least one combustion chamber is controlled by open-loop or closed-loop control in dependence on the time variable.

14. Method according to claim 13, wherein the quantity of the stabilizing gas and of the combustion gas is altered in dependence on the time variable, by the same factor.

15. Method according to claim 13 using an internal combustion engine having a plurality of combustion chambers, wherein an individual time variable is calculated for each combustion chamber, and the time variable is calculated as a maximum value, minimum value, mean value or median of the individual time variables.

16. Method according to claim 13, wherein during the combustion, a pressure progression in the at least one combustion chamber is measured by means of the at least one sensor, and used to calculate the time variable.

17. Method according to claim 16, wherein a heating progression is calculated from the difference of the pressure progression and a motored pressure progression, and a cumulative heating progression is calculated as an integral of the heating progression, and the cumulative heating progression is used to calculate the time variable and/or the individual time variable.

18. Method according to claim 17, wherein an instant of time at which the cumulative heating progression attains a defined proportion of its maximum is used as a time variable or as an individual time variable, wherein the proportion is between 5% and 20%, or between 30% and 80%, preferably between 40% and 65%, and particularly preferably is 50%.

19. Method according to claim 16, preferably using the 50% proportion of the cumulative heating progression, wherein the time variable and/or the individual time variable is indicated by means of a piston position, expressed as an angular position of a corresponding crankshaft cranking, measured from the top dead centre in the direction of rotation of the crankshaft, characterized in that the quantity of the stabilizing gas supplied to the at least one combustion chamber is controlled, by open-loop or closed-loop control, to a reference value of a 50% mass fraction burned point.

20. Method according to claim 16, wherein for the purpose of calculating the time variable and/or the individual time variable, a first point located on the pressure progression and a second point located on the pressure progression are selected, wherein an absolute value of the pressure progression and/or a gradient of the pressure progression is used as a criterion for the selection of the first point and/or of the second point, and in that a value between time coordinates of the first point and of the second point is determined for the time variable and/or for the individual time variable, wherein a division of 50% is preferably used.
